(19) United States
(12) Patent Application Publication
(10) Pub. No.: US 2022/0163636 A1
(43) Pub. Date: May 26, 2022

(54) ACTIVE TEMPERATURE CONTROL FOR REDUCING BACKGROUND NOISE IN A LIDAR SYSTEM

(71) Applicant: Beijing Voyager Technology Co., Ltd., Beijing (CN)

(72) Inventors: Yu-Ching Yeh, Mountain View, CA (US); Yue Lu, Mountain View, CA (US); Youmin Wang, Mountain View, CA (US)

(21) Appl. No.: 17/103,646

(22) Filed: Nov. 24, 2020

(51) Int. Cl. G01S 7/481; G01S 7/497; G01S 17/931; F25B 21/02

(52) U.S. Cl. CPC G01S 7/4817; G01S 7/497; F25B 2321/0212; F25B 21/02; G01S 17/931

(57) ABSTRACT

An active temperature controlled laser for a LiDAR system is provided. The laser is heated to a minimum target temperature to narrow the ambient temperature range of operation. The heating can be done by a thermoelectric cooler (TEC) or a separate heating element, such as a heating resistor(s). The heater is deactivated when the temperature sensor reports an environment temperature greater than the minimum target temperature. In addition, a TEC controller is coupled to the TEC, and is configured to control the TEC so that the temperature output of the temperature measurement device stays within a designated temperature range. This limits temperature-induced variations in the wavelength of the laser beam to within a designated wavelength range, allowing the use of a narrow band pass filter to reduce environmental light noise and improve the signal-to-noise ratio of the detected signal.

### BACKGROUND OF THE INVENTION

Unless otherwise indicated herein, the materials described in this section are not prior art to the claims in this application and are not admitted to be prior art by inclusion in this section. In particular, disparate technologies are discussed that it would not be obvious to discuss together absent the teachings of the present invention.

Modern vehicles are often equipped with sensors designed to detect objects and landscape features around the vehicle in real-time to enable technologies such as lane change assistance, collision avoidance, and autonomous driving. Some commonly used sensors include image sensors (e.g., infrared or visible light cameras), acoustic sensors (e.g., ultrasonic parking sensors), radio detection and ranging (RADAR) sensors, magnetometers (e.g., passive sensing of large ferrous objects, such as trucks, cars, or rail cars), and light detection and ranging (LiDAR) sensors.

A LiDAR system typically uses a light source and a light detection system to estimate distances to environmental features (e.g., pedestrians, vehicles, structures, plants, etc.). For example, a LiDAR system may transmit a light beam (e.g., a pulsed laser beam) to illuminate a target and then measure the time it takes for the transmitted light beam to arrive at the target and then return to a receiver near the transmitter or at a known location. In some LiDAR systems, the light beam emitted by the light source may be steered across a two-dimensional or three-dimensional region of interest according to a scanning pattern, to generate a “point cloud” that includes a collection of data points corresponding to target points in the region of interest. The data points in the point cloud may be dynamically and continuously updated, and may be used to estimate, for example, a distance, dimension, location, and speed of an object relative to the LiDAR system.

Light steering typically involves the projection of light in a pre-determined direction to facilitate, for example, the detection and ranging of an object, the illumination and scanning of an object, or the like. Light steering can be used in many different fields of applications including, for example, autonomous vehicles, medical diagnostic devices, etc., and can be configured to perform both transmission and reception of light. For example, a light steering transmitter may include a micro-mirror to control the projection direction of light to detect/image an object. Moreover, a light steering receiver may also include a micro-mirror to select a direction of incident light to be detected by the receiver, to avoid detecting other unwanted signals. A micro-mirror assembly typically includes a micro-mirror and an actuator. In a micro-mirror assembly, a micro-mirror can be connected to a substrate via a connection structure (e.g., a torsion bar, a spring, etc.) to form a pivot point. One such type of micro-mirror assembly can be a micro-electro-mechanical system (MEMS)-type structure that may be used for a light detection and ranging (LiDAR) system in an autonomous vehicle, which can be configured for detecting obstructions and determining their corresponding distances from the vehicle. LiDAR systems typically work by illuminating a target with an optical pulse and measuring the characteristics of the reflected return signal. The return signal is typically captured as a point cloud. The width of the optical-pulse often ranges from a few nanoseconds to several microseconds.

In a LiDAR system, laser diodes are used as the light source. The light is emitted from the transmitter, reflected by the object, and then captured by the receiver. The time-of-flight is measured to estimate the object distance. Since laser wavelength highly depends on the operating temperature, a wide-band optical filter is used before the receiver to support a large operating temperature range. However, the wide-band optical filter also allows a large amount of background light to come in, and thus increases the background noise. Thus, it is desirable to increase the signal-to-noise ratio (SNR).

### BRIEF SUMMARY OF THE INVENTION

Techniques disclosed herein relate generally to active temperature control of lasers that can be used in, for example, light detection and ranging (LiDAR) systems or other light beam steering systems. More specifically, and without limitation, disclosed herein is an apparatus and method for using active temperature control to stabilize the laser wavelength within a narrow band of wavelengths while exposed to a wide range of ambient temperatures. A narrow-band optical filter is used in front of the receiver, tuned to the passband of wavelengths corresponding to the temperatures at which the laser is controlled to operate. This thus improves the signal-to-noise ratio (SNR) in a LiDAR system.

In one embodiment, instead of just controlling the temperature to a narrow range with both heating and cooling, the laser diode is heated to a minimum target temperature to narrow the ambient temperature range of operation. This is accomplished by activating a heating element adjacent the laser diode when a temperature near the laser diode of less than a minimum target temperature (e.g., 0-25° C.) is detected. The heating can be done by a thermoelectric cooler (TEC) or a separate heating element, such as a heating resistor(s). The heater is deactivated when the temperature sensor reports a temperature greater than the minimum target temperature.

According to certain embodiments, a laser emits a laser beam with a wavelength dependent on temperature. A temperature measurement device is mounted adjacent the laser and provides a temperature output. A thermoelectric cooler (TEC) is coupled to the laser, and a heatsink is coupled to the TEC. A TEC controller is coupled to the TEC, and is configured to control the TEC so that the temperature output of the temperature measurement device stays within a designated temperature range. This limits temperature-induced variations in the wavelength of the laser beam to within a designated wavelength range. A temperature controller has an input coupled to the temperature output of the temperature measurement device, and has an output coupled to an input of the TEC controller. The temperature controller controls the TEC controller to maintain a temperature indicated by the temperature output of the temperature measurement device above a minimum target temperature. Alternately, the TEC can be eliminated, and a simple heater, such as heating resistors, could be used. For heating resistors, the temperature controller controls the current through a current driver to drive sufficient current to the heating resistor(s) when a monitored temperature adjacent the laser falls below the target temperature range.

According to certain embodiments, a TEC, and/or optionally another heater, controls the temperature experienced by a laser diode to a narrowed range of +20 to 85° C. The laser is heated to a minimum of 15-20° C. This narrowed range allows a less powerful (less expensive, less energy-consuming) TEC to be used, For example, a single stage TEC can be used.

In one embodiment, the narrowed temperature range is also used to control the alignment of the laser with scanning micro mirrors and other optics. A laser diode, laser diode package, and TEC will have different coefficients of thermal expansion (CTE). Thus, a change in temperature can cause stress between these elements, tilting the laser, and varying the alignment. By having a set minimum operating temperature, the laser device can be assembled at the set minimum operating temperature, so that it is insured to be within alignment at that temperature, and any changes in alignment will be minimized.

In one embodiment, a method of controlling the wavelength of a laser is provided. The first step is emitting a laser beam with a wavelength from a laser. Next is measuring a temperature near the laser. Then, the laser is either cooled by controlling a thermoelectric cooler (TEC) coupled to the laser and a heatsink (when the temperature is greater than a designated temperature range), or is heated when the temperature is less than the designated temperature range. The cooling and heating limit temperature-induced variations in the wavelength of the laser beam to within a designated wavelength range. The heating maintains the temperature above a minimum target temperature, wherein the minimum target temperature is at least 15-20° C.

The terms and expressions that have been employed are used as terms of description and not of limitation, and there is no intention in the use of such terms and expressions of excluding any equivalents of the features shown and described or portions thereof. It is recognized, however, that various modifications are possible within the scope of the systems and methods claimed. Thus, it should be understood that, although the present system and methods have been specifically disclosed by examples and optional features, modification and variation of the concepts herein disclosed should be recognized by those skilled in the art, and that such modifications and variations are considered to be within the scope of the systems and methods as defined by the appended claims.

This summary is not intended to identify key or essential features of the claimed subject matter, nor is it intended to be used in isolation to determine the scope of the claimed subject matter. The subject matter should be understood by reference to the appropriate portions of the entire specification of this disclosure, any or all drawings, and each claim.

The foregoing, together with other features and examples, will be described in more detail below in the following specification, claims, and accompanying drawings.

### BRIEF DESCRIPTION OF THE DRAWINGS

The features of the various embodiments described above, as well as other features and advantages of certain embodiments of the present invention, will be more apparent from the following detailed description taken in conjunction with the accompanying drawings, in which:

FIG. 1 shows an autonomous vehicle with a LiDAR system, according to certain embodiments;

FIG. 2A shows an example of a light projection operation, according to certain embodiments;

FIG. 2B shows an example of a light detection operation, according to certain embodiments;

FIG. 3 shows an embodiment of an active temperature control system for a laser;

FIG. 4 is a diagram of the temperature controller of FIG. 3 according to an embodiment;

FIG. 5 is a diagram of a laser diode and TEC assembly according to an embodiment;

FIG. 6 is a side view of a laser diode package and TEC assembly according to an embodiment;

FIG. 7 is a diagram showing the pin connections for a laser diode package and TEC assembly according to an embodiment;

FIG. 7A is a diagram with an enlargement of a portion of the diagram of FIG. 7 according to an embodiment;

FIG. 8 is a diagram of a LiDAR system incorporating the temperature controlled laser and narrow passband filter according to an embodiment;

FIG. 9 is a flowchart of a method for controlling a laser wavelength according to embodiments of the present invention;

FIG. 10 illustrates a simplified block diagram showing aspects of a LiDAR-based detection system, according to certain embodiments of the invention; and

FIG. 11 illustrates an example computer system that may be utilized to implement techniques disclosed herein, according to certain embodiments of the invention.

### DETAILED DESCRIPTION OF THE INVENTION

Aspects of the present disclosure relate generally to a LiDAR system, and more particularly to scanning an environment with a laser having a controlled wavelength.

In the following description, various examples of active temperature controlled laser structures are described. For purposes of explanation, specific configurations and details are set forth in order to provide a thorough understanding of the embodiments. However, it will be apparent to one skilled in the art that certain embodiments may be practiced or implemented without every detail disclosed. Furthermore, well-known features may be omitted or simplified in order to prevent any obfuscation of the novel features described herein.

According to embodiments, this invention describes a method to reduce background noise in a LiDAR system and to reduce misalignment due to temperature changes. The laser wavelength will change with the operating temperature. To support a large operating temperature range, a traditional way is to use a wide-band optical filter at the receiver to allow the reflected laser pulse to go through. This method has a significant drawback in that a large amount of background light will also be received and degrade the SNR for the system. This invention uses an active temperature control to stabilize the laser wavelength over a large range of operating temperature. Therefore, a narrow-band optical filter can be used at the receiver and get the benefit of higher SNR.

For LiDAR systems, an infrared (IR) laser is typically used so that the light is not visible and is not an annoyance or danger to the eyes. In particular, near IR band lasers are desirable. However, near IR band diode lasers generally have a large wavelength temperature dependence, e.g. a 0.3 nm/dC temp. coefficient. For a wide-temperature requirement such as the automotive LiDAR, this translates into a large laser wavelength shift with temperature. For example, a −40 to +85 degrees Celsius temperature range would result in ˜38 nm wavelength shift. That means at least a 38 nm optical filter window is needed on the receiver side to collect all the reflected laser power. Such a large filter window will inevitably introduce large solar/ambient infrared noise and thus reduce the overall Signal-to-Noise Ratio (SNR).

One solution is to use a temperature control system to stabilize the laser's working temperature and thus reduce the wavelength shift. This is done by setting a specific target temperature or a small temperature range. For example, a system can target to stabilize a working temperature to a range of +40 to +50 degree C., in an environment where the ambient temperature changes from −40 to +85. This can be done with devices such as a Thermoelectric Cooler (TEC). However, a powerful, expensive, and high energy-consuming TEC is required for such a large ambient temperature range. TECs come in multiple stages, which can be like a multi-story heatsink, also requiring a lot of room. Also, a TEC is less efficient in cooling than heating, so bringing down the temperature will generate a lot of heat that needs to be dissipated through a heatsink, requiring a large heatsink or even a fan. This additional heat may actually result in system instability (e.g. thermal runaway), in addition to inability to serve its original purpose of temperature control. Thus, it is difficult to achieve a practical solution for a LiDAR system.

The following high level summary is intended to provide a basic understanding of some of the novel innovations depicted in the figures and presented in the corresponding descriptions provided below. Techniques disclosed herein relate generally to active temperature controlled lasers that can be used in, for example, light detection and ranging (LiDAR) systems or other light beam steering systems.

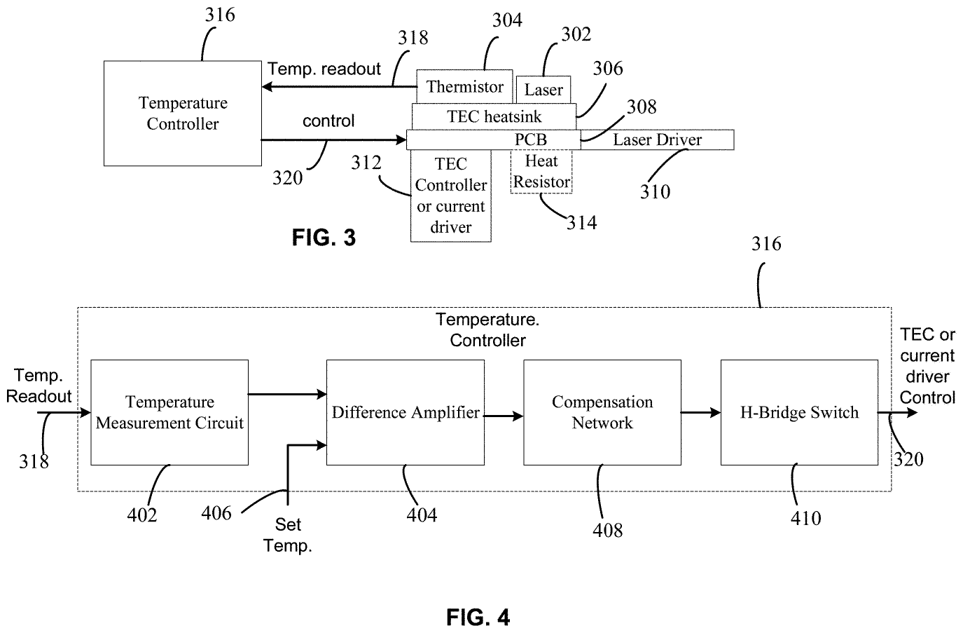

More specifically, and without limitation, disclosed herein are embodiments, illustrated in FIGS. 3-4, where, instead of just controlling the temperature to a narrow range with both heating and cooling, a laser diode 302 is heated to a minimum target temperature 406 to essentially narrow the ambient temperature range of operation. Thus, although the system is designed for an actual environment temperature range of −40 to +85° C., the ambient temperature that the laser diode sees is only, e.g., +20 to 85° C. This is accomplished by activating a heating element adjacent the laser diode when an environment temperature of less than 20° C. is detected. The heating can be done by the TEC (306, 312) or a separate heating element, such as a heating resistor(s) 314. The heater is deactivated when the temperature sensor (thermistor 304) reports an environment temperature greater than the minimum target temperature, e.g., 20° C.

An advantage of heating to provide a narrower temperature range is that the TEC then needs to control less, allowing a simpler TEC to be used, such as a single stage TEC. This means the TEC is less expensive, less bulky, uses less power and throws off less heat. An even simpler embodiment is using heating resistors instead of a TEC, as discussed in more detail below.

An additional issue in LiDAR systems is aligning the laser beam of the laser diode with the other optics in the system. Temperature changes can cause misalignment. Because of the differences in the Coefficient of Thermal Expansion (CTE) in the different semiconductor layers of the laser diode, the heatsink, the PCB, etc., the laser beam can tilt with temperature changes, causing alignment issues. By heating to a minimum target temperature, this tilt is both minimized and more predictable. The laser diode and accompanying optics can be aligned while heated to the minimum target temperature, rather than whatever the ambient temperature is during assembly. Accordingly, the heating control allows alignment issues to be minimized.

Generally, aspects of the invention are directed to implementations of light steering, which can be used in a number of different applications. For example, a Light Detection and Ranging (LiDAR) module of an autonomous vehicle may incorporate a light steering system. The light steering system can include a transmitter and receiver system to steer emitted incident light in different directions around a vehicle, and to receive reflected light off of objects around the vehicle using a sequential scanning process, which can be used to determine distances between the objects and the vehicle to facilitate autonomous navigation.

Light steering can be implemented by way of micro-mirror assemblies as part of an array, with each micro-mirror assembly having a movable micro-mirror and an actuator (or multiple actuators). The micro-mirrors and actuators can be formed as microelectromechanical systems (MEMS) on a semiconductor substrate, which allows for the integration of the MEMS with other circuitries (e.g., controller, interface circuits, etc.) on the semiconductor substrate, which can allow for simpler, easier, more robust, and cost-effective manufacturing processes.

### Typical System Environment for Certain Embodiments of the Invention

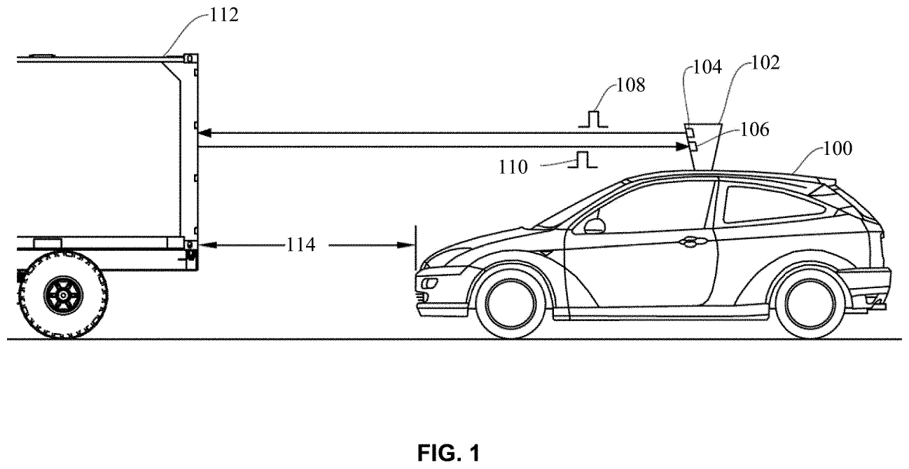

FIG. 1 illustrates an autonomous vehicle 100 in which the various embodiments described herein can be implemented. Autonomous vehicle 100 can include a LiDAR module 102. LiDAR module 102 allows autonomous vehicle 100 to perform object detection and ranging in a surrounding environment. Based on the result of object detection and ranging, autonomous vehicle 100 can drive according to the rules of the road and maneuver to avoid a collision with detected objects. LiDAR module 102 can include a light steering transmitter 104 and a receiver 106. Light steering transmitter 104 can project one or more light signals 108 at various directions (e.g., incident angles) at different times in any suitable scanning pattern, while receiver 106 can monitor for a light signal 110 which is generated by the reflection of light signal 108 by an object. Light signals 108 and 110 may include, for example, a light pulse, a frequency modulated continuous wave (FMCW) signal, an amplitude modulated continuous wave (AMCW) signal, etc. LiDAR module 102 can detect the object based on the reception of light signal 110, and can perform a ranging determination (e.g., a distance of the object) based on a time difference between light signals 108 and 110, as would be appreciated by one of ordinary skill in the art with the benefit of this disclosure. For example, as shown in FIG. 1, LiDAR module 102 can transmit light signal 108 at a direction directly in front of autonomous vehicle 100 at time T1 and receive light signal 110 reflected by an object 112 (e.g., another vehicle) at time T2. Based on the reception of light signal 110, LiDAR module 102 can determine that object 112 is directly in front of autonomous vehicle 100. Moreover, based on the time difference between T1 and T2, LiDAR module 102 can also determine a distance 114 between autonomous vehicle 100 and object 112. Autonomous vehicle 100 can thereby adjust its speed (e.g., slowing or stopping) to avoid collision with object 112 based on the detection and ranging of object 112 by LiDAR module 102.

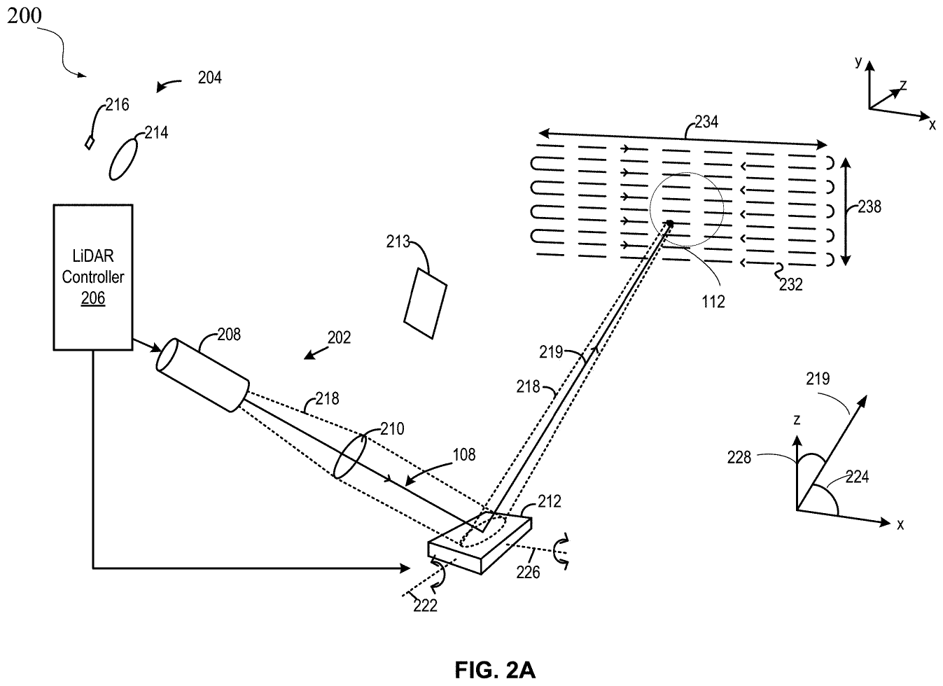

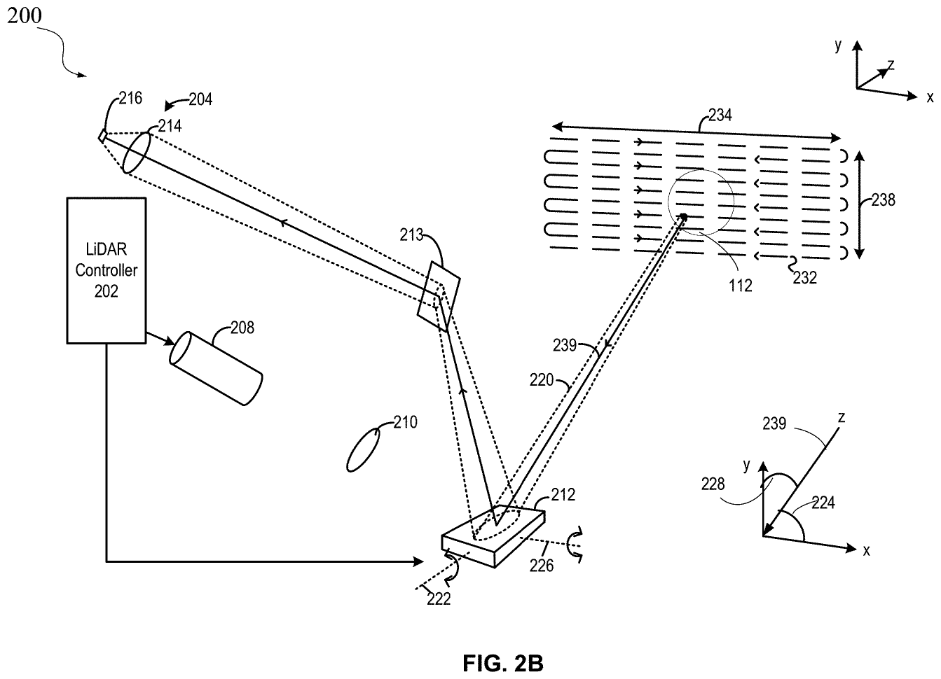

FIGS. 2A and FIG. 2B illustrate simplified block diagrams of an example of a LiDAR module 200 according to certain embodiments. LiDAR module 200 may be an example of LiDAR system 102, and may include a transmitter 202, a receiver 204, and LiDAR controller 206, which may be configured to control the operations of transmitter 202 and receiver 204. Transmitter 202 may include a light source 208 and a collimator lens 210, and receiver 204 can include a lens 214 and a photodetector 216. LiDAR module 200 may further include a mirror assembly 212 (also referred to as a “mirror structure”) and a beam splitter 213. In some embodiments, LiDAR module 102, transmitter 202 and receiver 204 can be configured as a coaxial system to share mirror assembly 212 to perform light steering operations, with beam splitter 213 configured to reflect incident light reflected by mirror assembly 212 to receiver 204.

FIG. 2A shows an example of a light projection operation, according to certain embodiments. To project light, LiDAR controller 206 can control light source 208 (e.g., a pulsed laser diode, a source of FMCW signal, AMCW signal, etc.) to transmit light signal 108 as part of light beam 218. Light beam 218 can disperse upon leaving light source 208 and can be converted into collimated light beam 218 by collimator lens 210. Collimated light beam 218 can be incident upon a mirror assembly 212, which can reflect collimated light beam 218 to steer it along an output projection path 219 towards object 112. Mirror assembly 212 can include one or more rotatable mirrors. FIG. 2A illustrates mirror assembly 212 as having one mirror; however, a micro-mirror array may include multiple micro-mirror assemblies that can collectively provide the steering capability described herein. Mirror assembly 212 can further include one or more actuators (not shown in FIG. 2A) to rotate the rotatable mirrors. The actuators can rotate the rotatable mirrors around a first axis 222, and can rotate the rotatable mirrors along a second axis 226. The rotation around first axis 222 can change a first angle 224 of output projection path 219 with respect to a first dimension (e.g., the x-axis), whereas the rotation around second axis 226 can change a second angle 228 of output projection path 219 with respect to a second dimension (e.g., the z-axis). LiDAR controller 206 can control the actuators to produce different combinations of angles of rotation around first axis 222 and second axis 226 such that the movement of output projection path 219 can follow a scanning pattern 232. A range 234 of movement of output projection path 219 along the x-axis, as well as a range 238 of movement of output projection path 219 along the z-axis, can define a FOV. An object within the FOV, such as object 112, can receive and reflect collimated light beam 218 to form a reflected light signal, which can be received by receiver 204 and detected by the LiDAR module, as further described below with respect to FIG. 2B. In certain embodiments, mirror assembly 212 can include one or more comb spines with comb electrodes (see, e.g., FIG. 3), as will be described in further detail below.

FIG. 2B shows an example of a light detection operation, according to certain embodiments. LiDAR controller 206 can select an incident light direction 239 for detection of incident light by receiver 204. The selection can be based on setting the angles of rotation of the rotatable mirrors of mirror assembly 212, such that only light beam 220 propagating along light direction 239 gets reflected to beam splitter 213, which can then divert light beam 220 to photodetector 216 via collimator lens 214. With such arrangements, receiver 204 can selectively receive signals that are relevant for the ranging/imaging of object 112 (or any other object within the FOV), such as light signal 110 generated by the reflection of collimated light beam 218 by object 112, and not to receive other signals. As a result, the effect of environmental disturbance on the ranging and imaging of the object can be reduced, and the system performance may be improved.

### Active Temperature Control for Reducing Background Noise

FIG. 3 shows an embodiment of an active temperature control system for a laser. A laser device 302 and a thermistor 304 are mounted on a printed circuit board (PCB) 308. A thermoelectric cooler (TEC) consists of a TEC heatsink 306 and a TEC controller 312. The TEC heatsink 306 can optionally be mounted either inside or outside of the laser 302 module package. The thermistor 304 is placed close to the laser 302 to sense the laser temperature. The temperature information will be read out from the thermistor and sent to a temperature controller 316 on a temperature readout line 318. The temperature controller can be a dedicated microcontroller or can share the same central processing unit with the overall LiDAR module, or any other controller in the system. The temperature controller 316 compares the sensed temperature and a temperature set point (e.g., the minimum target temperature), and then generates the appropriate TEC control output on output line 320 to control the TEC controller 312. If the temperature of the thermistor goes above the target temperature range, the controller can change the target temperature from the minimum target temperature to a maximum target temperature, to cause cooling to initiate. This negative feedback control loop will stabilize the laser temperature and its wavelength under a wide ambient temperature range. In one embodiment, a heating resistor(s) 314 is added. As shown, TEC controller 312 and optional heat resistor 314 are mounted on the underside of PCB 308. A laser driver 310 is formed in the PCB 308. Alternately, the heating resistor could be mounted adjacent laser 302, or inside the package for laser 302.

FIG. 4 is a diagram of the temperature controller 316 of FIG. 3 according to an embodiment. Temperature readout line 318 from FIG. 3 is provided to the input of a temperature measurement circuit 402. An output of temperature measurement circuit 402 is provided to a first input of a difference amplifier 404. A second input to the difference amplifier is a set temperature 406, which corresponds to the target minimum temperature or the target maximum temperature. Difference amplifier 404 is then coupled to a compensation network 408, which in turn provides an output to an H-bridge switch 410. The output of the H-bridge switch is TEC control line 320.

In an embodiment using only heating resistors, and not a TEC, the controller of FIG. 4 can be simplified. The temperature adjacent to the laser die is sensed with the temperature controller 316. If the temperature goes below the desired temperature range, a current driver 312 is activated to pump current into the heating resistor 314. The temperature is constantly monitored and fed back to the temperature controller 316. The temperature controller 316 will decide how much current needs to be pumped into the resistor in real-time to maintain the target temperature, using compensation network 408. The compensation network 408 can be either hardware or software or a combination. The software can include compensation algorithms such as a PD (Proportional-Derivative) or PID (Proportional-Integral-Derivative) controller. H-Bridge Switch 410 can be eliminated from temperature controller 316 in this embodiment. Also, the TEC controller and TEC heatsink 306 would be eliminated in this heating resistor only embodiment. This embodiment can only heat, and not cool, to achieve the desired temperature range. Thus, the temperature range is chosen at the high end of the operating temperature range, so that cooling is not needed. In one embodiment, the target or designated temperature range corresponds to an ambient temperature range of +65/70-85 degrees Celsius.

In one embodiment, the operating environment temperature range generally ise −40-85 degrees Celsius. Due to the laser's self-heating when operating, its junction temperature will generally be increased by around 10-20 degrees Celsius vs. the environmental temperature. Because of that, any sensing thermistor close to the laser will sense a temperature generally higher than the environmental temperature by a number of degrees. Thus, a laser diode indicated as working in an ambient temperature range up to +85 degrees Celsius is really working up to +95 to +105 degrees Celsius. With only a heating element, only the lower end of the operating range is controllable. But that still significantly reduces the range of wavelengths that will be emitteed. In one embodiment, the controls are set so that the laser diode is heated to a minimum temperature of +35 or +40 degrees Celsius. In most environments, the ambient heat will not significantly increase the operating temperature, thus providing a narrow range of operating temperatures at the laser diode. Thus, the heating control clips any temperature from −30 to +35/40, only permitting higher temperatures. If the sense thermistor reads a target temperature value below the lower bound of the regulating range (e.g., 40 degrees Celsius), the heater is turned on and there is continuously monitoring of the temperature. Once the thermistor reading reaches the target temperature, the heater is turned off. The control loop will do this on/off operation in real-time to try to maintain the temperature to be at the target temperature—i.e. +40 degrees Celsius in one example. However, if the thermistor sensing reading is already above the target temperature, the heater will not be turned on. Other values of the target temperature may be used. In another embodiment, the target temperature is a temperature in the range of +15 to +70 degrees Celsius.

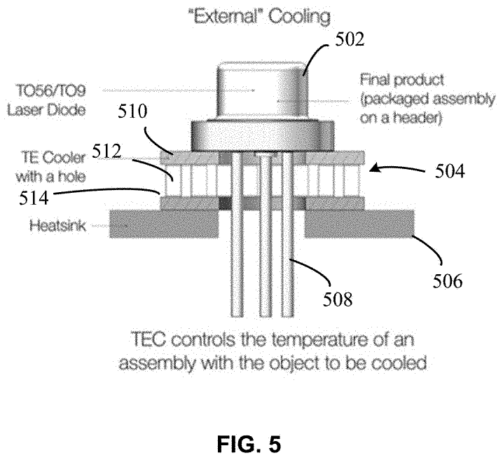

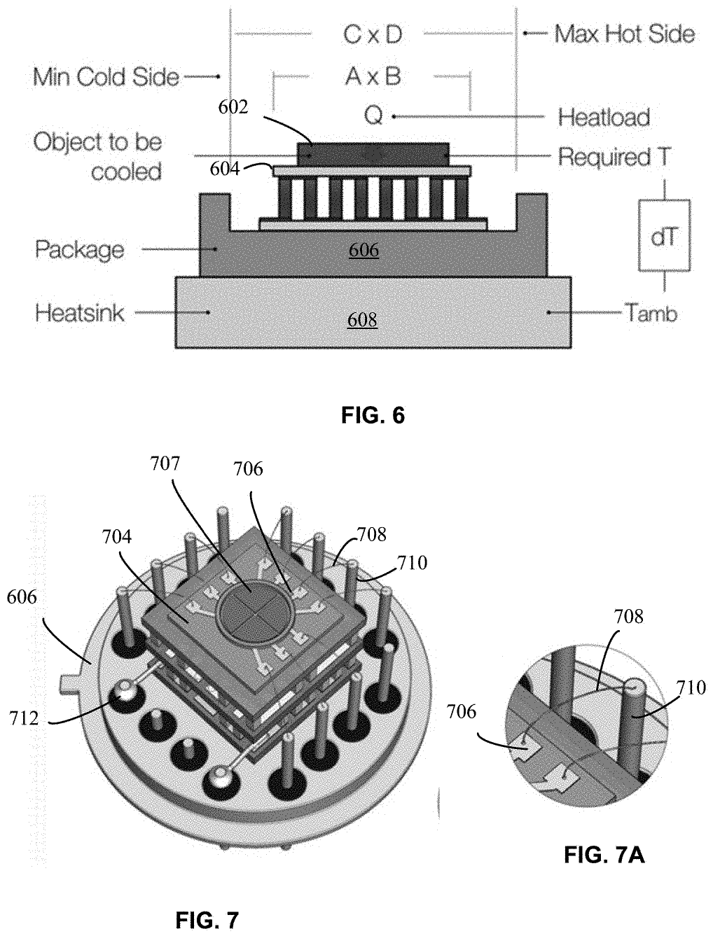

FIG. 5 is a diagram of a laser diode and TEC assembly according to an embodiment. A laser diode package 502 is mounted on a thermoelectric cooler (TEC) 504. Thermoelectric cooler 504 includes ceramic layers 510 and 514, with P and N semiconductors 512 in between. This is mounted on top of the heatsink 506 which includes openings for the pins 508 of the laser diode package 502. Depending on the dimension and material of the TEC, they can have different efficiencies for removing the heat from the heat load. The TEC itself consumes power to remove heat from the heat load, but itself also generates heat into the system. To optimize the TEC performance, a high efficiency TEC is chosen. Thus, the total system power consumption and heat is lower. Different types of TECs may be used depending on the system requirements, such as integrated in the package (shown in FIGS. 6, 7) or outside of the package (FIG. 5).

FIG. 6 is a side view diagram of a laser diode package and TEC assembly according to an embodiment. An object to be cooled, 602, is the laser diode. This is connected to the TEC 604 which is mounted inside the laser diode package 606 in this embodiment. The package 606 is in turn mounted on a heatsink 608. As shown, there is a temperature differential dT between the ambient temperature of the heatsink and a required temperature of the laser.

FIG. 6 illustrates the parameters to take into consideration to find the optimal type of TEC to use. A primary set of parameters is:

1. Maximum ambient temperature.

2. Ambient conditions (gas, vacuum).

3. Total heat load.

4. Maximum required difference in temperature (dT) from the ambient temperature.

5. The minimum required cold side temperature.

6. The maximum available space for the hot side.

A secondary set of parameters is:

7. The TEC height limit.

8. Any electrical power limits.

9. The heatsink thermal resistance.

10. The package type and materials.

FIG. 7 is a diagram showing the pin connections for a laser diode package and TEC assembly according to an embodiment. Shown is an inside cutaway view of the package 606 for the laser diode. This diagram illustrates the extra heat load from the wires, pins and contacts. A PCB 704 has a series of contacts 706 onto which wires 708 are bonded and connected to pins 710 also shown are ground pins 712. While a VCSEL laser 707 is shown, in one embodiment an edge emitting laser is used instead.

FIG. 7A is a diagram with an enlargement of a portion of the diagram of FIG. 7 according to an embodiment. As can be seen, wire 708 provides a connection from pins 710 to contact region 706 on the PCB of the laser diode package. This extra heat is taken into account when determining what type of TEC to use. The heat coming from the wires can be estimated by the following simplified formula:

$${Q}_{wires} = N \times K \times S \text{/} L \times dT \qquad ( 1 )$$

### Where:

N=number of wires,
K=wire material thermal conductivity,
S=wire cross section,
L=wire length, and
dT—temperature difference between TEC cold side and header (heat exchange side).

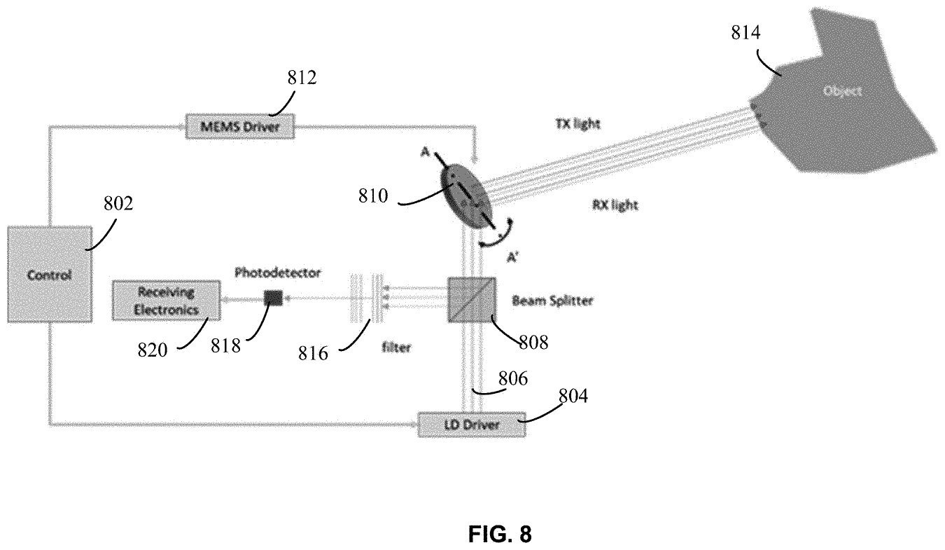

FIG. 8 is a diagram of a LiDAR system incorporating the temperature controlled laser and narrow passband filter according to an embodiment. A controller 802 controls a laser driver and laser 804, which emits a laser beam 806. The laser beam 806 passes through a beam splitter 808 and is scanned by rotating micro-mirrors 810 across an object 814 to be detected. The movement of the micro-mirrors is controlled by a MEMS driver 812 under the control of controller 802. The reflected beams are again directed off of the micro-mirrors 810 to beam splitter 808, which then redirects the reflected beams to a filter 816. The filtered light is provided to a photodetector 818, which is then processed by receiving electronics 820.

Filter 816 is designed to have a passband corresponding to the controlled wavelength of the laser diode by virtue of limiting the temperature range of the laser diode and the minimum temperature. Filter 816 can have a fixed passband, or can be an adaptive filter which can be controlled in the field to have a passband which tracks the temperature range of the laser. Thus, the filter can be designed for a particular laser temperature range, cutting off wavelengths produced by temperatures below and above that temperature range. In one embodiment, the filter is centered around the desired operating wavelength. In one embodiment, the filter range starts at the wavelength of the laser at the controlled target minimum temperature, and extends only to wavelengths generated above that temperature. In one embodiment, the temperature is controlled to avoid 0-50 degrees Fahrenheit, but allow 50-100 degrees. A variety of temperature ranges could be used to provide the desired passband, and the specific ranges will depend on the characteristics of the particular laser chosen. For example, the temperature range can be changed depending on the optimal operating wavelength of the laser, or other characteristics of the laser design. Various ranges could be chosen, such as 20-85° C., 15-75° C., 25-50° C., etc. Any type of filter can be used, including an absorptive filter, an interference filter or a dichroic filter. Multiple filters may be used to achieve the passband in one embodiment.

### Temperature Effect on Alignment

Stress develops in the interface between the chip (die) and the package because of a mismatch in CTE (coefficient of thermal expansion) of the two materials. For example, a die could be mainly made of silicon and an enclosure could be a ceramic package which is made of alumina. The CTEs of these two materials are different and they expand and contract at different rates with temperature. Alumina expands and contracts more than silicon, and thus stress develops at the interface of the two materials. This stress is transmitted to the devices in the substrate.

Thus, with changes of temperature, the laser may tilt due to the difference in thermal expansion. This tilting changes the alignment of the laser with the optics used in a LiDAR system, such as the micro mirrors used to scan the laser beam across an environment to be detected. Some consequences of misalignment include: (1) worse (larger) laser beam quality and thus larger energy loss, resulting in a shorter detection distance; (2) worse (larger) laser beam quality and thus worse resolution; and (3) the laser beam location can shift, resulting in in accuracy in the point cloud's position. By limiting the range of temperatures to a designated temperature range, the change of alignment is limited. The temperature range is chosen to provide a change in alignment of less than 15 micrometers.

Additionally, a minimum operating temperature for the laser is maintained by heating the laser as needed. The assembly conditions are set to be at or above this minimum temperature, to insure that the initial alignment is within the desired scope for the minimum set temperature. In one embodiment, the micro mirrors may be heated to the same target minimum temperature to maintain alignment. The micro mirror package can also be assembled at the same target minimum temperature.

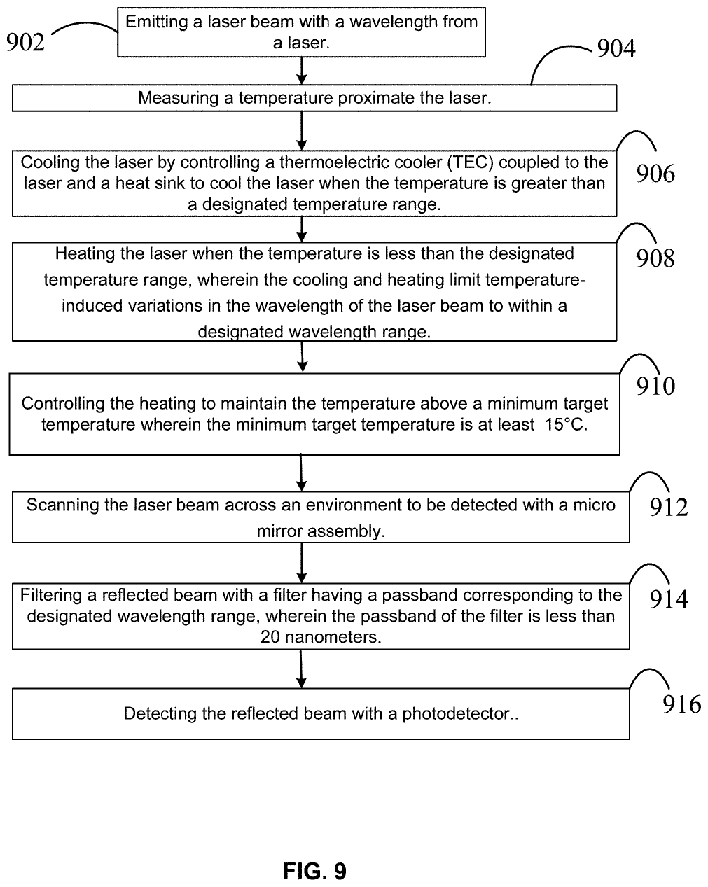

FIG. 9 is a flowchart of a method according to embodiments of the present invention. Step 902 is emitting a laser beam with a wavelength from a laser. Step 904 is measuring a temperature proximate the laser. Step 906 is cooling the laser by controlling a thermoelectric cooler (TEC) coupled to the laser and a heatsink to cool the laser when the temperature is greater than a designated temperature range. Step 908 is heating the laser when the temperature is less than the designated temperature range, wherein the cooling and heating limit temperature-induced variations in the wavelength of the laser beam to within a designated wavelength range. Step 910 is controlling the heating to maintain the temperature above a minimum target temperature, wherein the minimum target temperature is at least 15° C.

In one embodiment, further steps include step 912, scanning the laser beam across an environment to be detected with a micro mirror assembly. In step 914, the reflected beam is filtered with a filter having a passband corresponding to the designated wavelength range. Step 916 is detecting the reflected beam with a photodetector. In one embodiment, the passband of the filter is less than 20 nanometers (nm). In another embodiment, it is less than 15 nm.

In summary, in one embodiment, an apparatus for controlling the wavelength of a laser beam during temperature changes is provided. The apparatus comprises the following elements:
a laser 707 emits a laser beam 806 with a wavelength;
a temperature measurement device 304 is mounted adjacent the laser and has a temperature output;
a heat control element 306 and/or 314 is mounted proximate to the laser;
a heat control circuit 312 is coupled to the heat control element, and configured to control the heat control element so that the temperature output of the temperature measurement device stays within a designated temperature range, thereby limiting temperature-induced variations in the wavelength of the laser beam to within a designated wavelength range; and
a temperature controller 316 has an input coupled to the temperature output of the temperature measurement device and has an output control line coupled to an input of the heat control circuit, the temperature controller being configured to control the heat control circuit to maintain a temperature indicated by the temperature output of the temperature measurement device above a minimum target temperature.

In another embodiment, an apparatus for beam steering in a Light Detection and Ranging (LiDAR) system of an autonomous vehicle is provided. The apparatus comprises the following elements:
a printed circuit board 308;
at least one laser package 502 for emitting at least one laser beam 806 with a wavelength, the laser package being mounted on the printed circuit board, the laser package including:
a laser diode 302;
a thermistor 304 mounted adjacent the laser diode and having a temperature output;
a thermoelectric cooler (TEC) 504 coupled to the laser diode;
a heatsink 506 coupled to the TEC;
a TEC controller 312 coupled to the TEC, and configured to control the TEC so that the temperature output of the thermistor stays within a designated temperature range, thereby limiting temperature-induced variations in the wavelength of the laser beam to within a designated wavelength range;
a temperature controller 316 having an input 318 coupled to the temperature output of the thermistor and having an output control line 320 coupled to an input of the TEC controller, the temperature controller being configured to control the TEC controller to maintain a temperature indicated by the temperature output of the thermistor above a minimum target temperature, wherein the minimum target temperature is at least 0 degrees Celsius;
an optical assembly (808, 810, 816) including a micro mirror 819, mounted to scan a laser beam from the laser diode across an environment 814 to be detected;
a filter 816 mounted to intercept a reflected beam directed to the micro mirror, the filter having a passband corresponding to the designated wavelength range;
at least one detector 818 for detecting the reflected beam; and
a system controller 802 configured to control the laser diode and the optical assembly.

### Example LiDAR System Implementing Aspects of Embodiments Herein

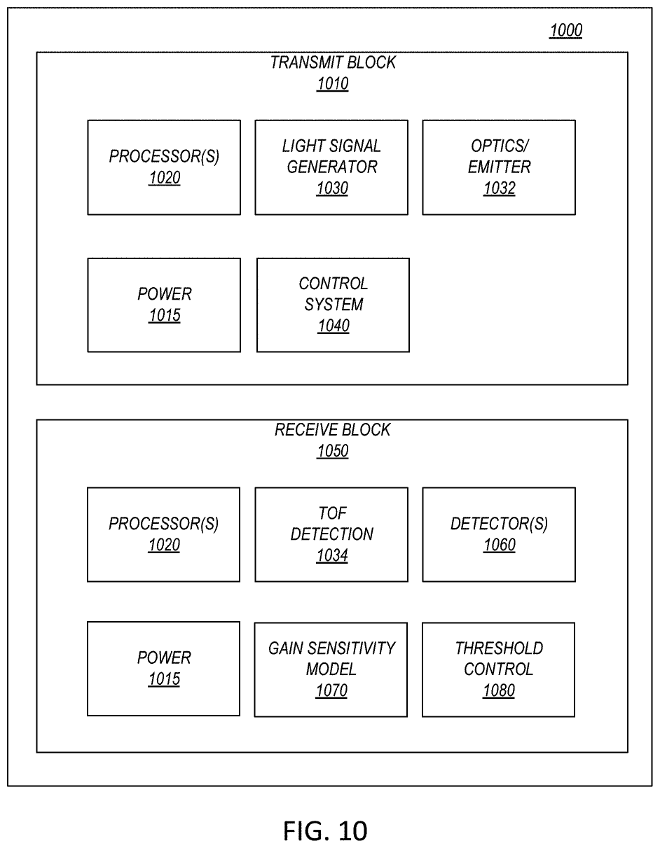

FIG. 10 illustrates a simplified block diagram showing aspects of a LiDAR-based detection system 1000, according to certain embodiments, in which the embodiments described above can be imbedded and controlled. System 1000 may be configured to transmit, detect, and process LiDAR signals to perform object detection as described above with regard to LiDAR system 1000 described in FIG. 1. In general, a LiDAR system 1000 includes one or more transmitters (e.g., transmit block 1010) and one or more receivers (e.g., receive block 1050). LiDAR system 1000 may further include additional systems that are not shown or described to prevent obfuscation of the novel features described herein.

Transmit block 1010, as described above, can incorporate a number of systems that facilitate that generation and emission of a light signal, including dispersion patterns (e.g., 360 degree planar detection), pulse shaping and frequency control, Time-Of-Flight (TOF) measurements, and any other control systems to enable the LiDAR system to emit pulses in the manner described above. In the simplified representation of FIG. 10, transmit block 1010 can include processor(s) 1020, light signal generator 1030, optics/emitter module 1032, power block 1015 and control system 1040. Some or all of system blocks 1030-1040 can be in electrical communication with processor(s) 1020.

In certain embodiments, processor(s) 1020 may include one or more microprocessors (μCs) and can be configured to control the operation of system 1000. Alternatively or additionally, processor 1020 may include one or more microcontrollers (MCUs), digital signal processors (DSPs), or the like, with supporting hardware, firmware (e.g., memory, programmable I/Os, etc.), and/or software, as would be appreciated by one of ordinary skill in the art. Alternatively, MCUs, μCs, DSPs, ASIC, programmable logic device, and the like, may be configured in other system blocks of system 1000. For example, control system block 1040 may include a local processor to certain control parameters (e.g., operation of the emitter). In particular, the TEC can be controlled to achieve the desired wavelength range and minimum temperature wavelength. Processor(s) 1020 may control some or all aspects of transmit block 1010 (e.g., optics/emitter 1032, control system 1040, dual sided mirror 220 position as shown in FIG. 1, position sensitive device 250, etc.), receive block 1050 (e.g., processor(s) 1020) or any aspects of LiDAR system 1000. In some embodiments, multiple processors may enable increased performance characteristics in system 1000 (e.g., speed and bandwidth), however multiple processors are not required, nor necessarily germane to the novelty of the embodiments described herein. Alternatively or additionally, certain aspects of processing can be performed by analog electronic design, as would be understood by one of ordinary skill in the art.

Light signal generator 1030 may include circuitry (e.g., a laser diode) configured to generate a light signal, which can be used as the LiDAR send signal, according to certain embodiments. In some cases, light signal generator 1030 may generate a laser that is used to generate a continuous or pulsed laser beam at any suitable electromagnetic wavelengths spanning the visible light spectrum and non-visible light spectrum (e.g., ultraviolet and infra-red). In some embodiments, lasers are commonly in the range of 600-1200 nm, although other wavelengths are possible, as would be appreciated by one of ordinary skill in the art.

Optics/Emitter block 1032 (also referred to as transmitter 1032) may include one or more arrays of mirrors (including but not limited to dual sided mirror 220 as described above in FIGS. 1-6) for redirecting and/or aiming the emitted laser pulse, mechanical structures to control spinning and/or moving of the emitter system, or other system to affect the system field-of-view, as would be appreciated by one of ordinary skill in the art with the benefit of this disclosure. For instance, some systems may incorporate a beam expander (e.g., convex lens system) in the emitter block that can help reduce beam divergence and increase the beam diameter. These improved performance characteristics may mitigate background return scatter that may add noise to the return signal. In some cases, optics/emitter block 1032 may include a beam splitter to divert and sample a portion of the pulsed signal. For instance, the sampled signal may be used to initiate the TOF clock. In some cases, the sample can be used as a reference to compare with backscatter signals. Some embodiments may employ micro electromechanical mirrors (MEMS) that can reorient light to a target field. Alternatively or additionally, multi-phased arrays of lasers may be used. Any suitable system may be used to emit the LiDAR send pulses, as would be appreciated by one of ordinary skill in the art.

Power block 1015 can be configured to generate power for transmit block 1010, receive block 1050, as well as manage power distribution, charging, power efficiency, and the like. In some embodiments, power management block 1015 can include a battery (not shown), and a power grid within system 1000 to provide power to each subsystem (e.g., control system 1040, etc.). The functions provided by power management block 1015 may be subsumed by other elements within transmit block 1010, or may provide power to any system in LiDAR system 1000. Alternatively, some embodiments may not include a dedicated power block and power may be supplied by a number of individual sources that may be independent of one another.

Control system 1040 may control aspects of light signal generation (e.g., pulse shaping), optics/emitter control, TOF timing, or any other function described herein. In some cases, aspects of control system 1040 may be subsumed by processor(s) 1020, light signal generator 1030, or any block within transmit block 1010, or LiDAR system 1000 in general.

Receive block 1050 may include circuitry configured to detect and process a return light pulse to determine a distance of an object, and in some cases determine the dimensions of the object, the velocity and/or acceleration of the object, and the like. Processor(s) 1065 may be configured to perform operations such as processing received return pulses from detectors(s) 1060, controlling the operation of TOF module 1034, controlling threshold control module 1080, or any other aspect of the functions of receive block 1050 or LiDAR system 1000 in general.

TOF module 1034 may include a counter for measuring the time-of-flight of a round trip for a send and return signal. In some cases, TOF module 1034 may be subsumed by other modules in LiDAR system 1000, such as control system 1040, optics/emitter 1032, or other entity. TOF modules 1034 may implement return “windows” that limit a time that LiDAR system 1000 looks for a particular pulse to be returned. For example, a return window may be limited to a maximum amount of time it would take a pulse to return from a maximum range location (e.g., 250 m). Some embodiments may incorporate a buffer time (e.g., maximum time plus 10%). TOF module 1034 may operate independently or may be controlled by other system block, such as processor(s) 1020, as described above. In some embodiments, the transmit block may also include a TOF detection module. One of ordinary skill in the art with the benefit of this disclosure would appreciate the many modifications, variations, and alternative ways of implementing the TOF detection block in system 1000.

Detector(s) 1060 may detect incoming return signals that have reflected off of one or more objects. In some cases, LiDAR system 1000 may employ spectral filtering based on wavelength, polarization, and/or range to help reduce interference, filter unwanted frequencies, or other deleterious signals that may be detected. In particular, a narrow passband filter can be used, either static or dynamic. A passband as narrow as 20 or even 15 nm may be used. Typically, detector(s) 1060 can detect an intensity of light and records data about the return signal (e.g., via coherent detection, photon counting, analog signal detection, or the like). Detector (s) 1060 can use any suitable photodetector technology including solid state photodetectors (e.g., silicon avalanche photodiodes, complimentary metal-oxide semiconductors (CMOS), charge-coupled devices (CCD), hybrid CMOS/CCD devices) or photomultipliers. In some cases, a single receiver may be used or multiple receivers may be configured to operate in parallel.

Gain sensitivity model 1070 may include systems and/or algorithms for determining a gain sensitivity profile that can be adapted to a particular object detection threshold. The gain sensitivity profile can be modified based on a distance (range value) of a detected object (e.g., based on TOF measurements). In some cases, the gain profile may cause an object detection threshold to change at a rate that is inversely proportional with respect to a magnitude of the object range value. A gain sensitivity profile may be generated by hardware/software/firmware, or gain sensor model 1070 may employ one or more look up tables (e.g., stored in a local or remote database) that can associate a gain value with a particular detected distance or associate an appropriate mathematical relationship there between (e.g., apply a particular gain at a detected object distance that is 10% of a maximum range of the LiDAR system, apply a different gain at 15% of the maximum range, etc.). In some cases, a Lambertian model may be used to apply a gain sensitivity profile to an object detection threshold. The Lambertian model typically represents perfectly diffuse (matte) surfaces by a constant bidirectional reflectance distribution function (BRDF), which provides reliable results in the LiDAR system as described herein. However, any suitable gain sensitivity profile can be used including, but not limited to, Oren-Nayar model, Nanrahan-Krueger model, Cook-Torrence model, Diffuse BRDF model, Limmel-Seeliger model, Blinn-Phong model, Ward model, HTSG model, Fitted Lafortune model, or the like. One of ordinary skill in the art with the benefit of this disclosure would understand the many alternatives, modifications, and applications thereof.

Threshold control block 1080 may set an object detection threshold for LiDAR system 1000. For example, threshold control block 1080 may set an object detection threshold over a certain full range of detection for LiDAR system 1000. The object detection threshold may be determined based on a number of factors including, but not limited to, noise data (e.g., detected by one or more microphones) corresponding to an ambient noise level, and false positive data (typically a constant value) corresponding to a rate of false positive object detection occurrences for the LiDAR system. In some embodiments, the object detection threshold may be applied to the maximum range (furthest detectable distance) with the object detection threshold for distances ranging from the minimum detection range up to the maximum range being modified by a gain sensitivity model (e.g., Lambertian model).

Although certain systems may not be expressly discussed, they should be considered as part of system 1000, as would be understood by one of ordinary skill in the art. For example, system 1000 may include a bus system (e.g., CAMBUS) to transfer power and/or data to and from the different systems therein. In some embodiments, system 1000 may include a storage subsystem (not shown). A storage subsystem can store one or more software programs to be executed by processors (e.g., in processor(s) 1020). It should be understood that “software” can refer to sequences of instructions that, when executed by processing unit(s) (e.g., processors, processing devices, etc.), cause system 1000 to perform certain operations of software programs. The instructions can be stored as firmware residing in read only memory (ROM) and/or applications stored in media storage that can be read into memory for processing by processing devices. Software can be implemented as a single program or a collection of separate programs and can be stored in non-volatile storage and copied in whole or in part to volatile working memory during program execution. From a storage subsystem, processing devices can retrieve program instructions to execute in order to execute various operations (e.g., software-controlled spring auto-adjustment, etc.) as described herein. Some software controlled aspects of LiDAR system 1000 may include aspects of gain sensitivity model 1070, threshold control 1080, control system 1040, TOF module 1034, or any other aspect of LiDAR system 1000.

It should be appreciated that system 1000 is meant to be illustrative and that many variations and modifications are possible, as would be appreciated by one of ordinary skill in the art. System 1000 can include other functions or capabilities that are not specifically described here. For example, LiDAR system 1000 may include a communications block (not shown) configured to enable communication between LiDAR system 1000 and other systems of the vehicle or remote resource (e.g., remote servers), etc., according to certain embodiments. In such cases, the communications block can be configured to provide wireless connectivity in any suitable communication protocol (e.g., radio-frequency (RF), Bluetooth, BLE, infra-red (IR), ZigBee, Z-Wave, Wi-Fi, or a combination thereof).

While system 1000 is described with reference to particular blocks (e.g., threshold control block 1080), it is to be understood that these blocks are defined for understanding certain embodiments of the invention and it is not implied or intended that embodiments are limited to a particular physical arrangement of component parts. The individual blocks need not correspond to physically distinct components. Blocks can be configured to perform various operations, e.g., by programming a processor or providing appropriate processes, and various blocks may or may not be reconfigurable depending on how the initial configuration is obtained. Certain embodiments can be realized in a variety of apparatuses including electronic devices implemented using any combination of circuitry and software. Furthermore, aspects and/or portions of system 1000 may be combined with or operated by other sub-systems as informed by design. For example, power management block 1015 and/or threshold control block 1080 may be integrated with processor(s) 1020 instead of functioning as separate entities.

### Example Computer Systems Implementing Aspects of Embodiments Herein

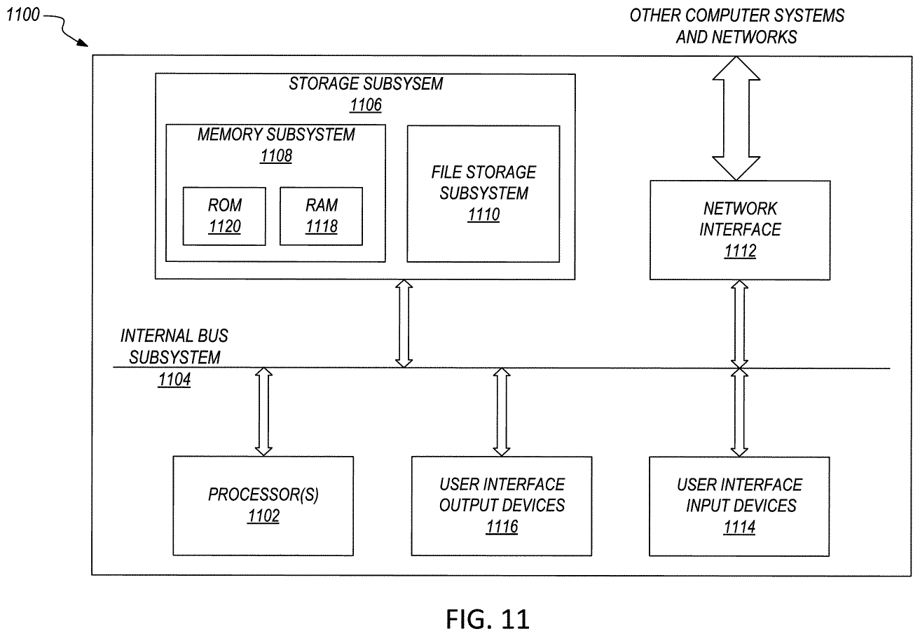

FIG. 11 is a simplified block diagram of a computing system 1100 configured to operate aspects of a LiDAR-based detection system, according to certain embodiments. Computing system 1100 can be used to implement any of the systems and modules discussed above with respect to FIGS. 1-6. For example, computing system 1100 may operate aspects of threshold control 1080, TOF module 1034, processor(s) 1020, control system 1040, or any other element of LiDAR system 1000 or other system described herein. Computing system 1100 can include, for example, a field programmable gate array (FPGA), an application specific integrated circuit (ASIC), and a general purpose central processing unit (CPU), to implement the disclosed techniques, including the techniques described from FIG. 1-FIG. 9, such as controller 802. In some examples, computing system 1100 can also one or more processors 1102 that can communicate with a number of peripheral devices (e.g., input devices) via a bus subsystem 1104. Processors 1102 can be an FPGA, an ASIC, a CPU, etc. These peripheral devices can include storage subsystem 1106 (comprising memory subsystem 1108 and file storage subsystem 1110), user interface input devices 1114, user interface output devices 1116, and a network interface subsystem 1112.

In some examples, internal bus subsystem 1104 (e.g., CAMBUS) can provide a mechanism for letting the various components and subsystems of computer system 1100 communicate with each other as intended. Although internal bus subsystem 1104 is shown schematically as a single bus, alternative embodiments of the bus subsystem can utilize multiple buses. Additionally, network interface subsystem 1112 can serve as an interface for communicating data between computing system 1100 and other computer systems or networks. Embodiments of network interface subsystem 1112 can include wired interfaces (e.g., Ethernet, CAN, RS232, RS485, etc.) or wireless interfaces (e.g., ZigBee, Wi-Fi, cellular, etc.).

In some cases, user interface input devices 1114 can include a keyboard, pointing devices (e.g., mouse, trackball, touchpad, etc.), a barcode scanner, a touch-screen incorporated into a display, audio input devices (e.g., voice recognition systems, microphones, etc.), Human Machine Interfaces (HMI) and other types of input devices. In general, use of the term “input device” is intended to include all possible types of devices and mechanisms for inputting information into computing system 1100. Additionally, user interface output devices 1116 can include a display subsystem, a printer, or non-visual displays such as audio output devices, etc. The display subsystem can be any known type of display device. In general, use of the term “output device” is intended to include all possible types of devices and mechanisms for outputting information from computing system 1100.

Storage subsystem 1106 can include memory subsystem 1108 and file/disk storage subsystem 1110. Subsystems 1108 and 1110 represent non-transitory computer-readable storage media that can store program code and/or data that provide the functionality of embodiments of the present disclosure. In some embodiments, memory subsystem 1108 can include a number of memories including main random access memory (RAM) 1118 for storage of instructions and data during program execution and read-only memory (ROM) 1120 in which fixed instructions may be stored. File storage subsystem 1110 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 1100 is illustrative and not intended to limit embodiments of the present disclosure. Many other configurations having more or fewer components than system 1100 are possible.

The various embodiments further can be implemented in a wide variety of operating environments, which in some cases can include one or more user computers, computing devices or processing devices, which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially available protocols, such as TCP/IP, UDP, OSI, FTP, UPnP, NFS, CIFS, and the like. The network can be, for example, a local-area network, a wide-area network, a virtual private network, the Internet, an intranet, an extranet, a public switched telephone network, an infrared network, a wireless network, and any combination thereof.

In embodiments utilizing a network server, the network server can run any of a variety of server or mid-tier applications, including HTTP servers, FTP servers, CGI servers, data servers, Java servers, and business application servers. The server(s) also may be capable of executing programs or scripts in response to requests from user devices, such as by executing one or more applications that may be implemented as one or more scripts or programs written in any programming language, including but not limited to Java®, C, C# or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable storage media for containing code, or portions of code, can include any appropriate media known or used in the art such as, but not limited to, volatile and non-volatile, removable and non-removable media implemented in any method or technology for storage of information such as computer-readable instructions, data structures, program modules or other data, including RAM, ROM, Electrically Erasable Programmable Read-Only Memory (EEPROM), flash memory or other memory technology, CD-ROM, DVD or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments. However, computer-readable storage media does not include transitory media such as carrier waves or the like.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims. For instance, any of the examples, alternative examples, etc., and the concepts thereof may be applied to any other examples described and/or within the spirit and scope of the disclosure.

For example, instead of using a single laser to illuminate the array of MEMS mirrors, an array of mirrors may be used. Also, the pattern generation and decoding could be hard-wired, in firmware or in software in different embodiments.

The MEMS mirror structure of the present invention can be used in a variety of other applications than LIDAR. Light beam steering techniques can also be used in other optical systems, such as optical display systems (e.g., TVs), optical sensing systems, optical imaging systems, and the like. In various light beam steering systems, the light beam may be steered by, for example, a rotating platform driven by a motor, a multi-dimensional mechanical stage, a Galvo-controlled mirror, a resonant fiber, an array of microelectromechanical (MEMS) mirrors, or any combination thereof. A MEMS micro-mirror may be rotated around a pivot or connection point by, for example, a micro-motor, an electromagnetic actuator, an electrostatic actuator, or a piezoelectric actuator.

The MEMS mirror structure of the present invention can have the mirror mass driven by different types of actuators. In some light steering systems, the transmitted or received light beam may be steered by an array of micro-mirrors. Each micro-mirror may rotate around a pivot or connection point to deflect light incident on the micro-mirror to desired directions. The performance of the micro-mirrors may directly affect the performance of the light steering system, such as the field of view (FOV), the quality of the point cloud, and the quality of the image generated using a light steering system. For example, to increase the detection range and the FOV of a LiDAR system, micro-mirrors with large rotation angles and large apertures may be used, which may cause an increase in the maximum displacement and the moment of inertia of the micro-mirrors. To achieve a high resolution, a device with a high resonant frequency may be used, which may be achieved using a rotating structure with a high stiffness. It may be difficult to achieve this desired performance using electrostatic actuated micro-mirrors because comb fingers used in an electrostatic-actuated micro-mirror may not be able to provide the force and moment needed and may disengage at large rotation angles, in particular, when the aperture of the micro-mirror is increased to improve the detection range. Some piezoelectric actuators may be used to achieve large displacements and large scanning angles due to their ability to provide a substantially larger drive force than electrostatic-actuated types, with a relatively lower voltage.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

What is claimed is:

1. An apparatus for beam steering in a Light Detection and Ranging (LiDAR) system of an autonomous vehicle, the apparatus comprising:
a printed circuit board;
at least one laser package for emitting at least one laser beam with a wavelength, the laser package being mounted on the printed circuit board, the laser package including:
a laser diode;
a thermistor mounted adjacent the laser diode and having a temperature output;
a thermoelectric cooler (TEC) coupled to the laser diode;
a heatsink coupled to the TEC;
a TEC controller coupled to the TEC, and configured to control the TEC so that the temperature output of the thermistor stays within a designated temperature range, thereby limiting temperature-induced variations in the wavelength of the laser beam to within a designated wavelength range;
a temperature controller having an input coupled to the temperature output of the thermistor and having an output control line coupled to an input of the TEC controller, the temperature controller being configured to control the TEC controller to maintain a temperature indicated by the temperature output of the thermistor above a minimum target temperature, wherein the minimum target temperature is at least 0 degrees Celsius;
an optical assembly including a micro mirror, mounted to scan a laser beam from the laser diode across an environment to be detected;
a filter mounted to intercept a reflected beam directed to the micro mirror, the filter having a passband corresponding to the designated wavelength range;
at least one detector for detecting the reflected beam; and
a system controller configured to control the laser diode and the optical assembly.

2. The apparatus of claim 1 wherein the passband of the filter is less than 20 nanometers.

3. The apparatus of claim 1 further comprising:
a heating resistor mounted proximate to the laser diode; and
the temperature controller being coupled to the heating resistor to cause the heating resistor to maintain a temperature output of the thermistor to above the minimum target temperature.

4. The apparatus of claim 3 wherein the heating resistor comprises multiple resistors.

5. The apparatus of claim 4 wherein the temperature controller provides a varying voltage level to the heating resistor to maintain the temperature output of the thermistor to above the minimum target temperature.

6. The apparatus of claim 1 wherein the minimum target temperature is at least 15° C.

7. The apparatus of claim 1 wherein the TEC is a single stage TEC.

8. An apparatus comprising:
a laser which emits a laser beam with a wavelength;
a temperature measurement device mounted adjacent the laser and having a temperature output;
a heat control element mounted proximate to the laser;
a heat control circuit coupled to the heat control element, and configured to control the heat control element so that the temperature output of the temperature measurement device stays within a designated temperature range, thereby limiting temperature-induced variations in the wavelength of the laser beam to within a designated wavelength range; and
a temperature controller having an input coupled to the temperature output of the temperature measurement device and having an output control line coupled to an input of the heat control circuit, the temperature controller being configured to control the heat control circuit to maintain a temperature indicated by the temperature output of the temperature measurement device above a minimum target temperature.

9. The apparatus of claim 8 wherein the heat control element comprises:
a thermoelectric cooler (TEC) coupled to the laser;
a heatsink coupled to the TEC; and
the heat control circuit comprises
a TEC controller coupled to the TEC, and configured to control the TEC so that the temperature output of the temperature measurement device stays within a designated temperature range, thereby limiting temperature-induced variations in the wavelength of the laser beam to within a designated wavelength range.

10. The apparatus of claim 9 wherein the temperature controller comprises:
a temperature measurement circuit having an input coupled to the temperature output of the temperature measurement device;
a difference amplifier having a first input coupled to an output of the temperature measurement circuit and a second input coupled to a set temperature corresponding to the minimum target temperature;
a compensation network coupled to an output of the difference amplifier; and
an H-bridge switch coupled to an output of the compensation network and having a control output coupled to an input of the TEC controller.

11. The apparatus of claim 8 wherein the heat control element comprises at least one heating resistor, and the heat control circuit comprises a current driver coupled to the heating resistor.

12. The apparatus of claim 8 further comprising:
an optical assembly including a micro mirror, mounted to scan a laser beam from the laser across an environment to be detected; and
a filter mounted to intercept a reflected beam directed to the micro mirror, the filter having a passband corresponding to the designated wavelength range;
wherein the passband of the filter is less than 20 nanometers.

13. The apparatus of claim 12 further comprising:
a printed circuit board;
at least one laser package enclosing the laser for emitting the laser beam, the laser package being mounted on the printed circuit board;
wherein the printed circuit board, the laser package and the laser have different coefficients of thermal expansion that cause a change of alignment with temperature of the laser beam and the micro mirror; and
wherein the designated temperature range limits the change of alignment to be less than 15 micrometers.

14. The apparatus of claim 9 further comprising:
a heating resistor mounted proximate to the laser; and
the temperature controller being coupled to the heating resistor to cause the heating resistor to maintain a temperature output of the temperature measurement device above the minimum target temperature.

15. The apparatus of claim 8 wherein the minimum target temperature is at least 15° C.

16. The apparatus of claim 9 wherein the TEC is a single stage TEC.

17. A method comprising:
emitting a laser beam with a wavelength from a laser;
measuring a temperature proximate the laser;
cooling the laser by controlling a thermoelectric cooler (TEC) coupled to the laser and a heatsink to cool the laser when the temperature is greater than a designated temperature range;
heating the laser when the temperature is less than the designated temperature range;
wherein the cooling and heating limit temperature-induced variations in the wavelength of the laser beam to within a designated wavelength range; and
controlling the heating to maintain the temperature above a minimum target temperature.

18. The method of claim 17 wherein the minimum target temperature is at least 15° C.

19. The method of claim 17 further comprising:
scanning the laser beam across an environment to be detected with a micro mirror assembly;
filtering a reflected beam with a filter having a passband corresponding to the designated wavelength range; and
detecting the reflected beam with a photodetector.

20. The method of claim 19 wherein the passband of the filter is less than 20 nanometers.
